(19) United States
(12) Patent Application Publication
(10) Pub. No.: US 2022/0341085 A1
(43) Pub. Date: Oct. 27, 2022

(54) APPLIANCE FOR DRYING LAUNDRY AND METHOD FOR OPERATING SUCH AN APPLIANCE

(71) Applicant: BSH Hausgeraete GmbH, Muenchen (DE)

(72) Inventors: Alvaro Harbach, Berlin (DE); Reinhard Heyder, Berlin (DE); Andreas Stolze, Falkensee (DE)

(21) Appl. No.: 17/762,822

(22) PCT Filed: Sep. 17, 2020
(86) PCT No.: PCT/EP2020/075947

§ 371 Date: Mar. 23, 2022

(30) Foreign Application Priority Data
Sep. 25, 2019 (DE) 10 2019 214 687.2

(51) Int. Cl. D06F 58/20; D06F 58/24

(52) U.S. Cl. CPC D06F 58/206; D06F 58/24

(57) ABSTRACT

An appliance for drying laundry has an appliance housing, at least one open drying air duct situated inside the appliance housing, for sucking in ambient air during a drying process, and at least one heat pump, which is situated inside the appliance housing and is thermally coupled to the drying air duct. To reduce the energy consumption of such an appliance, the drying air duct has at least one air intake opening, which is situated inside the appliance housing and is situated in a section of the drying air duct upstream of a condenser of the heat pump in relation to an air mass flow through the drying air duct prevailing during the drying process.

Appliance for Drying Laundry and Method for Operating such an Appliance

The invention relates to an appliance for drying laundry, having an appliance housing, at least one open drying air duct arranged inside the appliance housing for drawing in ambient air during a drying process and at least one heat pump which is arranged inside the appliance housing and is thermally coupled to the drying air duct. Furthermore, the invention relates to a method for operating an appliance for drying laundry.

An appliance of the type mentioned in the introduction is for example known from EP 2 196 577 A1. In such an appliance, the drying air from the environment of the appliance and after entry into the appliance housing is drawn in through a condenser of the heat pump. The ambient air which has been drawn in is heated as it flows through the condenser and then flows further in the direction of a fan of the drying air duct. The heated drying air is compressed in the fan and is guided by means of the fan into a laundry drum or into a container of the appliance which surrounds the laundry drum radially on the outside and on the rear side. When drying damp laundry inside the laundry drum, the drying air inside the laundry drum is cooled and loaded with steam. The main portion of the drying air flows on from the laundry drum through a filter unit of the drying air duct, through an evaporator of the heat pump and, if required, through an additional heat exchanger of the heat pump and then leaves the appliance. However, as a result of leakages, parts of the drying air reach a front and a rear drum seal in an interior space of the appliance housing. This leakage of air leads to a deterioration of the condensation rate of the drying process, a lengthening of the drying process and therefore also a lengthening of power consumption of the appliance, which in turn leads to a higher energy use.

It is an object of the invention to reduce the energy consumption of an appliance for drying laundry.

This object is achieved by means of the independent claims. Advantageous embodiments are reproduced in the following description, the dependent claims and the figures, wherein these embodiments both in their own right or in different combinations of at least two of these embodiments can represent a further developing, in particular also preferred or advantageous, aspect of the invention. In this context, embodiments of the appliance can correspond to embodiments of the method, and vice versa, even if this is not explicitly indicated below in the individual case.

According to the invention, during a drying process by means of the air intake opening of the drying air duct arranged inside the appliance housing, a leakage of air inside the appliance housing is drawn into the drying air duct, mixed with the ambient air from the environment of the appliance drawn into the drying air ii duct and fed together with this ambient air to the condenser of the heat pump. This allows energy losses, which are caused by air leakages at the drying air duct inside the appliance housing, to be reincorporated into the current drying process. By mixing the drawn-in leakage air with the drawn-in ambient air, a mixed air is generated, the enthalpy of which is higher than the enthalpy of the ambient air by the amount of the enthalpy of the leakage air. Energy losses of the drying process are hereby reduced, whereby the drying process is shortened, the condensation rate of the drying process is increased and the energy requirement of the appliance is reduced. The invention therefore achieves an improvement in performance values of an appliance for drying laundry with a heat pump and an open drying air duct.

The drying air circuit can also have two or more air intake openings according to the invention. The drying air duct has at least one fan for conveying air through the drying air duct during a drying process. In addition, a section of the drying air duct is formed by a container of the appliance, in which a laundry drum is rotatably accommodated.

The appliance for drying laundry can for example be embodied as a tumble dryer, a washer-dryer or similar.

According to one advantageous embodiment, the air intake opening is connected communicatively via an air intake channel with an area of a base assembly of the appliance, which is arranged separately from a heat exchanger accommodating area of the base assembly and in which at least one compressor of the heat pump is arranged. The heat exchanger accommodating area can enclose the heat exchanger of the heat pump from a housing perspective to ensure that the drying air flows around and/or through the heat exchanger in the desired manner. In addition, an expansion unit of the heat pump can be arranged in the area of the base assembly which is arranged separately from the heat exchanger accommodating area. The air intake channel can run through a separating wall between the heat exchanger accommodating area and the area of the base assembly which is separate therefrom.

According to a further advantageous embodiment, the heat pump has in addition to an evaporator an additional heat exchanger, which is downstream of the evaporator as regards the air mass flow through the drying air duct and is directly upstream of an expansion unit of the coolant circuit or indirectly via the condenser as regards a coolant flow through a coolant circuit of the heat pump. As a result, the efficiency of the appliance is improved, leading to a further energy saving for a drying process.

According to a further advantageous embodiment, the additional heat exchanger is embodied as a subcooler downstream of the condenser or as a desuperheater upstream of the condenser. These embodiments of the additional heat exchanger differ as regards the respective pipework required for the heat pump depending on their use.

According to a method according to the invention for operating an appliance for drying laundry an air mass flow is fed to a condenser of a heat pump of the appliance arranged inside an appliance housing of the appliance, which consists partly of ambient air, which is drawn in by means of an open drying air duct of the appliance which is thermally coupled to the heat pump, and partly of drawn-in air from inside the appliance housing.

The advantages cited above in relation to the appliance correspondingly apply to the method. In particular the appliance can be used according to one of the aforementioned embodiments or a combination of at least two of these embodiments with one another for performing the method.

According to an advantageous embodiment air emerging from a container of the drying air duct, which accommodates a laundry drum of the appliance, is in addition cooled down by means of an additional heat exchanger of the heat pump, which is downstream of an evaporator of the heat pump as regards an air mass flow through the drying air duct and is directly upstream of an expansion unit of the heat pump or indirectly via a condenser of the heat pump as regards a coolant flow through a coolant circuit of the heat pump. The advantages cited above in relation to the corresponding embodiment of the appliance correspondingly apply to this embodiment.

The invention is explained below by way of example with reference to the attached figures by means of a preferred embodiment. In the figures:

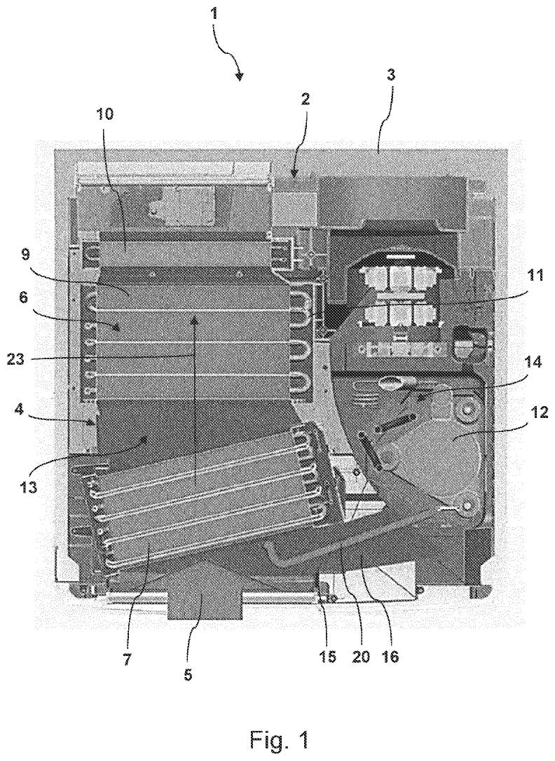

FIG. 1 shows a schematic sectional representation of an exemplary embodiment for an appliance according to the invention; and

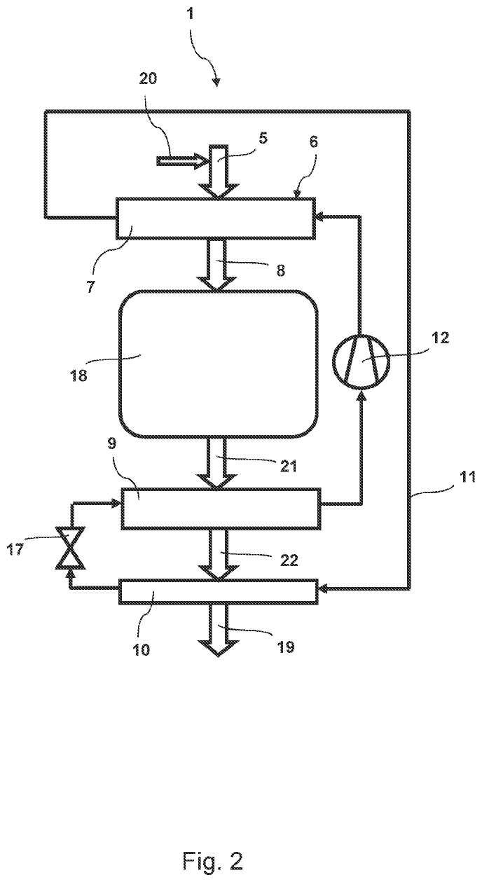

FIG. 2 shows a process circuit diagram of the appliance shown in FIG. 1.

In the figures, the same or functionally identical components are provided with the same reference characters. A repeated description of such components can be omitted in the following description of the figures.

FIG. 1 shows a schematic sectional representation of an exemplary embodiment for an appliance 1 for drying laundry according to the invention. In particular, a horizontal section of a base assembly 2 of the appliance 1 is shown.

The appliance 1 has an appliance housing 3 accommodating the base assembly 2, an open drying air duct 4 arranged inside the appliance housing 3 for drawing in ambient air according to the arrow 5 during a drying process, and a heat pump 6 arranged inside the appliance housing 3 and thermally coupled to the drying air duct 4.

The heat pump 6 has a condenser 7, an evaporator 9 downstream of the condenser 7 as regards an air mass flow through the drying air duct 4 indicated by the arrow 23 and an additional heat exchanger 10, which is downstream of the evaporator 9 as regards the air mass flow through the drying air duct 4 and is directly upstream of an expansion unit 17 of the coolant circuit 11 and downstream of the condenser 7 as regards a coolant flow through a coolant circuit 11 of the heat pump 6. The heat pump 6 also has a compressor 12. The condenser 7, the evaporator 9 and the additional heat exchanger 10 are arranged in a manner which is not shown in a heat pump area 13 which is radially externally closed in relation to the air mass flow, and are therefore arranged separately from an area 14 of the base assembly 2 in which the compressor 12 and the expansion unit are arranged. The additional heat exchanger 10 can be embodied as a subcooler.

The drying air duct 4 has an air intake opening 15, which is arranged inside the appliance housing 3 and is arranged at a section of the drying air duct 4 which is upstream of the condenser 7 of the heat pump 6 as regards the given air mass flow through the drying air duct 4 during the drying process. The air intake opening 15 is connected communicatively via an air intake channel 16 with the area 14 of the base assembly 2, which is arranged separately from the heat exchanger accommodating area 13 of the base assembly 2. Inside the appliance housing 3, leakage air is drawn in according to the arrow 20 by means of the air intake channel 16.

FIG. 2 shows a process circuit diagram of the appliance 1 shown in FIG. 1. Also shown are the expansion unit 17 of the heat pump 6 and a container 18 which accommodates a laundry drum (not shown). Ambient air flows into the appliance 1 according to the arrow 5 and is fed through the appliance 1 or its drying air duct not shown in FIG. 2 according to the arrows 8, 21, 22, for which purpose a fan (not shown) is used. The air emerging from the additional heat exchanger 10 is removed from the appliance 1 according to the arrow 19. According to the arrow 20, drawn-in leakage air inside the appliance housing which is not shown is also fed to the drawn-in ambient air.

### LIST OF REFERENCE CHARACTERS:

1 Appliance

2 Base assembly

3 Appliance housing

4 Drying air duct

5 Arrow (incoming ambient air)

6 Heat pump

7 Condenser

8 Arrow (air mass flow to 18)

9 Evaporator

10 Additional heat exchanger

11 Coolant circuit

12 Compressor

13 Heat pump area of 2

14 Area of 2

15 Air intake opening of 4

16 Air intake channel

17 Expansion unit

18 Container

19 Arrow (outgoing drying air)

20 Arrow (drawn-in leakage air)

21 Arrow (air mass flow to 9)

22 Arrow (air mass flow to 10)

23 Arrow (air mass flow through 4)

1-6. (canceled)

7. An appliance for drying laundry, the appliance comprising:
an appliance housing;
at least one open drying air duct disposed inside said appliance housing for drawing in ambient air during a drying process;
at least one heat pump disposed inside said appliance housing and thermally coupled to said at one open drying air duct, said at least one heat pump having a condenser; and
said at one open drying air duct having at least one air intake opening, disposed inside said appliance housing and disposed at a section of said at least one open drying air duct which is upstream of said condenser of said heat pump as regards a given air mass flow through said at least one open air drying duct during the drying process.

8. The appliance according to claim 7,
further comprising a base assembly disposed in said appliance housing and having a heat exchanger accommodating area;
further comprising an air intake channel disposed in said appliance housing;
wherein said at least one heat pump has at least one compressor; and
wherein said at least air intake opening is connected communicatively via said air intake channel with an area of said base assembly, which is disposed separately from said heat exchanger accommodating area of said base assembly and in which said at least one compressor of said at least one heat pump is disposed.

9. The appliance according to claim 7, wherein said at least one heat pump has an evaporator, a coolant circuit with an expansion unit, an additional heat exchanger disposed downstream of said evaporator as regards the given air mass flow through said at least one open drying air duct and is directly upstream of said expansion unit of said coolant circuit or indirectly via said condenser as regards a coolant flow through said coolant circuit of said at least one heat pump.

10. The appliance according to claim 9, wherein said additional heat exchanger is embodied as a subcooler downstream of said condenser or as a desuperheater upstream of said condenser.

11. A method for operating an appliance for drying laundry, which comprises the steps of:
feeding an air mass flow to a condenser of a heat pump of the appliance disposed inside an appliance housing of the appliance, which consists partly of ambient air, which is drawn in by means of an open drying air duct of the appliance which is thermally coupled to the heat pump, and partly of drawn-in air from inside the appliance housing.

12. The method according to claim 11, wherein air emerging from a container of the open drying air duct, which accommodates a laundry drum of the appliance, is in addition heated by means of an additional heat exchanger of the heat pump, which is downstream of an evaporator of the heat pump as regards an air mass flow through the open drying air duct and is directly upstream of an expansion unit of the heat pump or indirectly via the condenser as regards a coolant flow through a coolant circuit of the heat pump.
